(19) United States
(12) Patent Application Publication
(10) Pub. No.: US 2026/0365148 A1
(43) Pub. Date: Nov. 19, 2026

(54) MASTER CYLINDER FOR BRAKING SYSTEM

(71) Applicant: Robert Bosch GmbH, Stuttgart (DE)

(72) Inventors: David Coffin, Maisons-Alfort (FR); Moustafa Lachgar, Franconville (FR); Nicolas Quiniou, Villemomble (FR)

(21) Appl. No.: 19/661,992

(22) Filed: Apr. 29, 2026

(30) Foreign Application Priority Data
May 14, 2025 (FR) 2505106

(51) Int. Cl. B60T 11/16

(52) U.S. Cl. CPC B60T 11/165

(57) ABSTRACT

A master cylinder for a motor vehicle braking system. The master cylinder includes a base body defining an inner chamber in which a piston slides back and forth to supply pressurized hydraulic fluid to the wheel brakes of the vehicle, via an electronic control unit, the braking system including a brake pedal intended to be actuated by the driver to request braking, which pedal is connected to a brake actuator, a front face of which bears on the rear face of the piston, the actuator, on receiving a braking request signal, generating a thrust on the piston, characterized in that the inner surface of the chamber of the master cylinder against which the piston slides has no anodization layer, while the outer surface of the piston sliding against the inner surface of the master cylinder includes an anodization layer.

### FIELD

The present disclosure relates to a master cylinder, in particular a tandem master cylinder (TMC) supplying pressurized hydraulic fluid to the wheel brakes of a vehicle, in particular a motor vehicle, as well as to a braking system including such a master cylinder and to a vehicle including such a braking system.

### BACKGROUND INFORMATION

The related art describes a master cylinder for a motor vehicle braking system, including a base body defining an inner chamber in which a piston slides back and forth to supply pressurized hydraulic fluid to the wheel brakes of the vehicle, via an electronic control unit, the braking system including a brake pedal intended to be actuated by the driver to request braking, which pedal is connected to a brake actuator, a front face of which bears on the rear face of the piston, the actuator, on receiving a braking request signal, generating a thrust on the piston.

It would be desirable to have a master cylinder, in particular a TMC, which is easier to manufacture while also having a long service life, in particular a service life adapted to the desired service life of the braking system.

### SUMMARY

According to a first aspect of the present disclosure, the inner surface of the chamber of the master cylinder against which the piston slides has no anodization layer, while the outer surface of the piston sliding against the inner surface of the master cylinder includes an anodization layer.

According to a second aspect of the present disclosure, independent of the first aspect, but which can be favorably combined therewith, the material of the actuator and the material of the base body of the master cylinder are selected in such a way that a difference in electrical potential remains low, in particular less than 2 volts; for example, they are made of the same material, in particular aluminum.

According to a third aspect of the present disclosure, independent of the first and second aspects, but which can be favorably combined with each or both of them, when the master cylinder is new, the roughness Rz of the inner surface of the master cylinder is less than 10 micrometers, preferably less than 5 micrometers, even more preferably less than 4 micrometers.

Preferably, the rear face of the piston against which the front face of the actuator bears has a domed shape, with its convexity preferably facing the actuator.

Preferably, the front face of the actuator is a flat surface, preferably perpendicular to the actuator axis.

Preferably, the domed rear face of the piston is in the shape of a spherical cap, and preferably, the apex is arranged on the piston axis.

The present disclosure also relates to a motor vehicle braking system including a master cylinder in accordance with the present disclosure and to a vehicle, in particular a motor vehicle, including a braking system in accordance with the present disclosure.

By way of example only, an example embodiment of the present disclosure is described with reference to the figures.

### BRIEF DESCRIPTION OF THE DRAWINGS

FIG. 1 schematically shows part of a vehicle including a braking system including a TMC according to an example embodiment of the present disclosure.

FIG. 2 is a cross-sectional view of the actuator and part of the TMC of FIG. 1.

### DETAILED DESCRIPTION OF EXAMPLE EMBODIMENTS

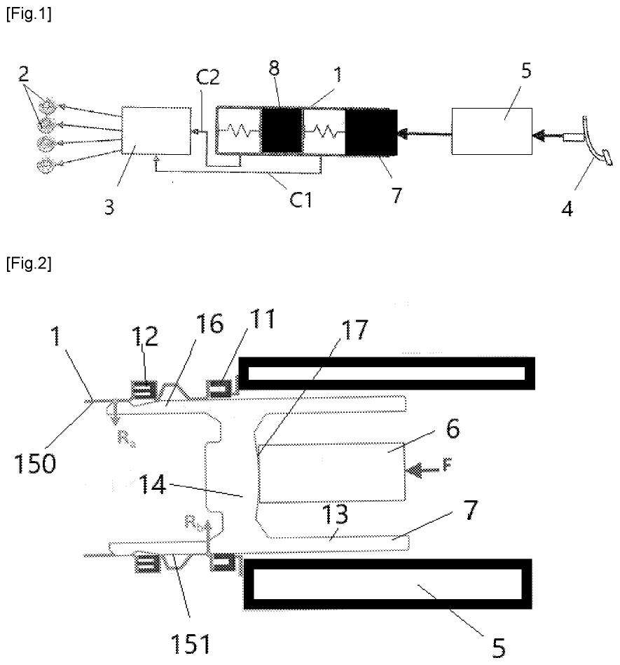

FIG. 1 schematically shows a hydroelectric braking system in a motor vehicle, comprising a master cylinder 1 supplied from a brake fluid reservoir (not shown) and supplying pressurized compensation brake fluid to the calipers 2 of the wheel brakes via an ESP electronic control unit 3.

The system comprises a brake pedal 4 actuated by the driver, who presses the pedal to request braking. The pedal 4 is connected to an interface with a travel sensor (not shown) generating a signal representing the braking request from the driver. This signal is transmitted to an electromechanical braking actuator 5 comprising a motor actuating a plunger 6 acting on the primary piston 7 of the master cylinder 1, thereby controlling braking by the master cylinder 1.

The master cylinder 1 is a TMC including two pistons, namely a primary piston 7 and a secondary piston 8 (see FIG. 1), supplying respective brake circuits C1, C2 via the ESP 2, to apply pressurized brake fluid to the wheel brakes in a programmed manner.

FIG. 2 shows, in axial cross section, the part of the master cylinder 1 at the contact between the primary piston 7 and the plunger 6 of the actuator 5, the piston 7 sliding along axis X-X of the chamber of the master cylinder 1, which chamber also accommodates the secondary piston. The sealing between the piston 7 and the inner wall defining the chamber of the cylinder is achieved by seals 11 and cups 12.

The piston 7 is made up of a rear cylindrical skirt 13 terminating in a base 14 separating the chamber 15 delimited by the primary piston 7 in the master cylinder 1. On the side of the base 14 opposite the plunger 5, an extension 16 of the piston 7 extends, completing the outer cylindrical surface of the piston 7 sliding against the inner wall of the cylindrical chamber of the master cylinder 1.

The face of the base 14 facing backwards (toward the plunger) forms a domed, in particular spherical, bearing surface 17.

The plunger 6 is cylindrical in shape, with a flat front face.

In this way, the contact of the plunger 6 against the domed rear face of the base 14 of the piston 7 takes place at the apex of the doming, so that the actuator thrust F is always applied rigorously in the horizontal axis of the piston, as the piston moves.

The domed, in particular spherical, shape of the bearing surface ensures good contact with the flat surface of the plunger, avoiding local deformation of this flat surface to allow good transverse sliding of the plunger face with respect to its bearing point on the axis XX, thus avoiding inducing high transverse force components Ra and Rb.

### The Piston 12 Is Made of Aluminum, for Example.

The inner surface 150 of the wall defining the chamber of the master cylinder, along which inner surface the piston 7 slides, is not anodized. It is preferably made of aluminum. Conversely, the outer surface 151 of the piston 7, sliding against the inner surface 150, is anodized.

The roughness parameters of the surface 150 are adapted so that the level of wear over the entire service life of the braking system remains acceptable; acceptable meaning that no large particles or piston damage are generated.

In particular, no particles larger than 4 micrometers are created. Preferably, when the TMC is new, none of the roughnesses Ra, Rz and Rt of the inner surface of the master cylinder are greater than 4 micrometers.

1-8. (canceled)

9. A master cylinder for a motor vehicle braking system of a motor vehicle, comprising:
a base body defining an inner chamber in which a piston slides back and forth to supply pressurized hydraulic fluid to wheel brakes of the motor vehicle, via an electronic control unit, the braking system including a brake pedal configured to be actuated by the driver to request braking, the brake pedal is being connected to a brake actuator, a front face of the brake actuator bearing on a rear face of the piston, the actuator, on receiving a braking request signal, configured to generate a thrust on the piston, wherein an inner surface of the inner chamber of the master cylinder against which the piston slides has no anodization layer, and an outer surface of the piston sliding against the inner surface of the inner chamber of the master cylinder includes an anodization layer.

10. The master cylinder according to claim 9, wherein, when the master cylinder is new, a roughness Rz of the inner surface of the inner chamber of the master cylinder is less than 4 micrometers.

11. The master cylinder according to claim 9, wherein the rear face of the piston against which the front face of the actuator bears has a domed shape.

12. The master cylinder according to claim 11, wherein a convexity of the rear face of the piston faces the actuator.

13. The master cylinder according to claim 9, wherein the front face of the actuator is a flat surface.

14. The master cylinder according to claim 13, wherein the front face of the actuator is perpendicular to an axis of the actuator.

15. The master cylinder according to claim 11, wherein the rear face of the piston is in a shape of a spherical cap.

16. The master cylinder according to claim 16, wherein an apex of the spherical cap is arranged on a piston axis of the piston.

17. A motor vehicle braking system, comprising:
a master cylinder including:
a base body defining an inner chamber in which a piston slides back and forth to supply pressurized hydraulic fluid to wheel brakes of the motor vehicle, via an electronic control unit, the braking system including a brake pedal configured to be actuated by the driver to request braking, the brake pedal is being connected to a brake actuator, a front face of the brake actuator bearing on a rear face of the piston, the actuator, on receiving a braking request signal, configured to generate a thrust on the piston, wherein an inner surface of the inner chamber of the master cylinder against which the piston slides has no anodization layer, and an outer surface of the piston sliding against the inner surface of the inner chamber of the master cylinder includes an anodization layer.
